(19) United States
(12) Patent Application Publication
(10) Pub. No.: US 2022/0391927 A1
(43) Pub. Date: Dec. 8, 2022

(54) Remediation of Stale Online Accounts and Digital Exhaust

(71) Applicant: McAfee, LLC, San Jose, CA (US)

(72) Inventors: Shashank Jain, Bangalore (IN); Srikanth Nalluri, Bangalore (IN); Dattatraya Kulkarni, Bangalore (IN); Ram Sharan Singh, Bangalore (IN)

(73) Assignee: McAfee, LLC, San Jose, CA (US)

(21) Appl. No.: 17/400,204

(22) Filed: Aug. 12, 2021

(30) Foreign Application Priority Data
Jun. 3, 2021 (IN) 202141024726

(51) Int. Cl. G06Q 30/02; H04L 29/06

(52) U.S. Cl. CPC G06Q 30/0201; H04L 63/1441; H04L 63/1425; H04L 67/10

(57) ABSTRACT

In an example, there is disclosed an end-user computing apparatus, including a hardware platform, having a processor and a memory; and instructions encoded within the memory to provide two or more network activity scanners for a user's network activity; operate the two or more network activity scanners to locally analyze the user's network activity, identify a plurality of online accounts associated with the user, and compute respective account identities and usage contexts for the accounts; and send the account identities and usage contexts to an analysis service for identification of accounts to modify.

### CROSS REFERENCE TO RELATED APPLICATIONS

This application claims priority to Indian Provisional Application 202141024726, titled “A Mechanism for Discovery and Classification of Personal Digital Accounts,” filed Jun. 3, 2021, which is incorporated herein by reference in its entirety.

### Field of the Specification

This application relates in general to computer security, and more particularly though not exclusively to a system and method for remediation of stale online accounts and digital exhaust.

### BACKGROUND

Modern computing practice often results in users generating many online accounts, some of which are used infrequently.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a security ecosystem.

FIG. 2 is a block diagram of selected elements of a digital exhaust remediation ecosystem.

FIGS. 3A and 3B are block diagrams of selected elements of account aggregation.

FIG. 4 is a block diagram of selected elements of context enrichment.

FIG. 5 is a flow chart of a client method.

FIG. 6 is a flow chart of a cloud service method.

FIG. 7 is a block diagram of selected elements of a hardware platform.

FIG. 8 is a block diagram of selected elements of a processor.

FIG. 9 is a block diagram of selected elements of a trusted execution environment (TEE).

FIG. 10 is a block diagram of selected elements of a network function virtualization (NFV) infrastructure.

FIG. 11 is a block diagram of selected elements of a containerization infrastructure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an end-user computing apparatus. The end-user computing apparatus also includes a hardware platform, may include a processor and a memory. The apparatus also includes instructions encoded within the memory to: provide two or more network activity scanners for a user's network activity; operate the two or more network activity scanners to locally analyze the user's network activity, identify a plurality of online accounts associated with the user, and compute respective account identities and usage contexts for the accounts; and send the account identities and usage contexts to an analysis service for identification of accounts to modify. Other embodiments of this aspect include corresponding computer systems, apparatus, and computer programs recorded on one or more computer storage devices, each configured to perform the actions of the methods.

Implementations may include one or more of the following features. The end-user computing apparatus where the user contexts include message header and/or metadata for messages, and omits message content. The end-user computing apparatus is a mobile phone. The end-user computing apparatus is a tablet. The end-user computing apparatus is a laptop computer. The end-user computing apparatus is a desktop computer. The end-user computing apparatus is a workstation. The end-user computing apparatus is a netbook. The end-user computing apparatus is a convertible tablet. The analysis service is a cloud-based analysis service. The instructions are further to receive from the cloud-based analysis service a remedial action for an account, and implement the remedial action. Implementing the remedial action may include sending a message from the end-user computing apparatus to delete the account. Implementing the remedial action may include providing to the user instructions to delete the account. Implementing the remedial action may include providing a user interface for a one-click account reclamation. Implementing the remedial action may include querying the user for confirmation to delete the account. At least one of the network activity scanners is a scanner for a network activity other than email. At least one of the scanners is selected from the group may include of email headers, short messaging service, chat service, stored passwords, autofill data, internet history, installed applications and phone logs. At least one of the network activity scanners is an email scanner that scans email headers and not email bodies. The instructions are further to access a cloud-based uniform resource locator (URL) reputation service to identify potential account activity from email headers. Implementations of the described techniques may include hardware, a method or process, or computer software on a computer-accessible medium.

One general aspect includes one or more tangible. The non-transitory computer-readable storage media also includes use at least two device-local network activity scanners to analyze a user's online account activity. The media also includes identify a plurality of online accounts associated with the user. The media also includes compute respective account identities and usage contexts for the online accounts. The media also includes send the account identities and usage contexts to a cloud-based analysis service for identification of accounts to modify. Other embodiments of this aspect include corresponding computer systems, apparatus, and computer programs recorded on one or more computer storage devices, each configured to perform the actions of the methods.

Implementations may include one or more of the following features. The one or more tangible, non-transitory computer-readable media where the user contexts include message header and/or metadata for messages, and omits message content. The analysis service is a cloud-based analysis service. The instructions are further to receive from the cloud-based analysis service a remedial action for an account, and implement the remedial action. Implementing the remedial action may include sending a message from the end-user computing apparatus to delete the account. Implementing the remedial action may include providing to the user instructions to delete the account. Implementing the remedial action may include providing a user interface for a one-click account reclamation. Implementing the remedial action may include querying the user for confirmation to delete the account. At least one of the network activity scanners is a scanner for a network activity other than email. At least one of the scanners is selected from the group may include of email headers, short messaging service, chat service, stored passwords, internet history, and phone logs. At least one of the network activity scanners is an email scanner that scans email headers and not email bodies. The instructions are further to access a cloud-based URL reputation service to identify potential account activity from email headers. Implementations of the described techniques may include hardware, a method or process, or computer software on a computer-accessible medium.

One general aspect includes a computer-implemented method. The computer-implemented method also includes using at least two device-local network activity scanners, analyzing a user's online account activity. The method also includes identifying a plurality of online accounts associated with the user. The method also includes computing respective account identities and usage contexts for the accounts. The method also includes sending the account identities and usage contexts to a cloud-based analysis service for identification of accounts to modify. Other embodiments of this aspect include corresponding computer systems, apparatus, and computer programs recorded on one or more computer storage devices, each configured to perform the actions of the methods.

Implementations may include one or more of the following features. The method where the user contexts include message header and/or metadata for messages, and omits message content. An apparatus may include means for performing the method. The memory may include machine-readable instructions that, when executed, cause the apparatus to perform the method. At least one computer-readable medium may include instructions that, when executed, implement a method or realize an apparatus. The instructions are further to provide a guest host infrastructure. The instructions are further to aggregate account information from the usage contexts. Characterizing communications may include distinguishing marketing communications from non-marketing communications. The instructions are further to identify information about the URL from a web page hosted at the URL. The instructions are further to determine local governing law for the URL. The instructions are further to access a cloud-based URL reputation database for a URL associated with an online account. The instructions are further to determine personal information about the user associated with the online accounts. Determining that the online account is stale may include accounting for an account type, and an expected periodicity of interaction with the account type. The instructions are further to determine that an online account is stale, and delete or attempt to delete the online account. The instructions are further to attempt an automatic account deletion for an online account. The instructions are further to create a dummy account for an online account, and determine required steps to delete the dummy account. The instructions are further to send to the endpoint device instructions for deleting an online account. The apparatus is a computing system. The analysis service is a cloud-based analysis service. The method may include receiving from the cloud-based analysis service a remedial action for an account, and implement the remedial action. Implementing the remedial action may include sending a message from the end-user computing apparatus to delete the account. Implementing the remedial action may include providing a one-click user interface for reclaiming an account. Implementing the remedial action may include providing to the user instructions to delete the account. Implementing the remedial action may include querying the user for confirmation to delete the account. At least one of the network activity scanners is a scanner for a network activity other than email. At least one of the scanners is selected from the group may include of email headers, short messaging service, chat service, stored passwords, autofill data, internet history, and phone logs. The method may include accessing a cloud-based URL reputation service to identify potential account activity from email headers. The means for performing the method may include a processor and a memory. At least one of the network activity scanners is an email scanner that scans email headers and not email bodies. Implementations of the described techniques may include hardware, a method or process, or computer software on a computer-accessible medium.

One general aspect includes an analysis server. The analysis server also includes a hardware platform, may include a processor and a memory. The server also includes instructions encoded within the memory to instruct the processor to: receive from an endpoint device account identifiers for a plurality of online accounts associated with a user, and respective usage contexts for the plurality of online accounts; analyze the usage contexts to determine respective periodicities of user interaction for the online accounts; at least partly based on the periodicities, identify a stale account from among the plurality of online accounts; determine a remedial action for the stale account; and implement the remedial action. Other embodiments of this aspect include corresponding computer systems, apparatus, and computer programs recorded on one or more computer storage devices, each configured to perform the actions of the methods.

Implementations may include one or more of the following features. The analysis server where aggregating account information may include characterizing communications from an operator of an online account. Implementations of the described techniques may include hardware, a method or process, or computer software on a computer-accessible medium.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

In modern developed countries, internet usage is nearly universal. As part of this internet usage, users may create online accounts for hundreds of different services. These online digital accounts may be used, for example, to join social networking sites, order goods and services online, subscribe to entertainment services, subscribe to news or information services, join professional or community organizations, and do and perform many other types of activities. In creating these online digital accounts, users may necessarily or optionally share personal and sensitive data. These data are then stored on the servers of the operators of these many online services, and once the data have been submitted to the online service, they are essentially out of the control of the user. This can pose both a security and privacy risk for the user.

Many of these accounts are created on-the-fly to satisfy an immediate need and may then be completely forgotten. Others are created with the intent of interacting with them regularly, but a user may lose interest in some services or find a different service that better serves the user's interests. Thus, over time, users accumulate a large number of accounts, and forget about many of them.

The data stored on these many disparate online accounts may be referred to as “digital exhaust.” Digital exhaust is a trail that the user leaves behind him that contains personal, private, or security-sensitive information. If a bad actor gains access to this digital exhaust, or a part thereof, the bad actor may be able to compromise the user's security or even engage in illegal activity such as blackmail or ransom.

Furthermore, abuse of digital exhaust is not limited solely to bad actors. The various online services that provide accounts may collect, store, and share a user's privacy-sensitive data. The online services may exploit the digital exhaust, such as by collaborating with third parties and data brokers. Furthermore, the possibility of breaches and corresponding leaks of private and sensitive data elevates the associated risk.

Another risk is that users often recycle the same credentials (e.g., username and/or password) with similar patterns across many different accounts. Thus, the compromise of one account may make it significantly easier for a bad actor to compromise other accounts. This risk has been seen in practice, where some online service providers store clear text passwords or password hints on their servers, even though this is not considered a best security practice. If a user's commonly used password is compromised, then an attacker may be able to gain access to other online services using the same username and password. This increases the attacker's ability to further collect digital exhaust from the user.

Many user accounts also correspond to services that have either reached the end of their useful life or that have been supplanted by a superior service. For example, while Myspace remains a viable social media platform, Myspace usage has largely been supplanted by Facebook usage. Thus, many Myspace users have effectively abandoned the platform for Facebook, leaving behind them a trail of digital exhaust in the form of usernames, passwords, old posts, old relationships, and other. Such accounts may be referred to as zombie accounts, and such zombie accounts may hold user data with minimal security.

Research suggests that an average email address is associated with approximately 130 accounts. Additional research found that an average internet user may typically have as many as 150 accounts. However, the average user is unaware of most of these accounts. Because the user has forgotten about most of these accounts and no longer regularly uses the services associated with them, these accounts contribute to the user's personal digital exhaust, such as the amount of the user's personal digital assets that are shared with online accounts. This can pose a significant security risk for the user.

However, discovering accounts owned by a user, assessing sensitive data contained therein, and remediating such accounts is inherently a distributed problem, complicated by the fact that the users themselves might not know which accounts they own. Thus, a first step in remediating the risk of stale or zombie accounts may be to discover the user's digital exhaust, assess risk, and take remedial action to mitigate present and future risk.

The present specification provides a system and method for identifying such stale accounts and providing remedial action. The system and method may discover user's online accounts and identify digital exhaust. The system and method also provides an automated mechanism for identifying the user's diminishing interest in an account to qualify the account as either active or dormant. Furthermore, the system and method may provide a human-machine teaming-based approach with a privacy-aware mechanism of allowing users to reclaim their personal and sensitive data held by various online accounts.

An average user's online activities across various web applications and multiple devices can lead to the creation of a large number of online accounts. Whether knowingly or unknowingly, a common user will share a significant volume of personal information, such as identity (e.g., name, Social Security number, email, phone number, or others), financial data (e.g., bank details, account numbers, routing numbers, credit card details, account balances, or similar), location (e.g., address, GPS coordinates, or similar), behavior (e.g., likes, dislikes, or other), and health data. Sharing such personal and sensitive information with accounts contributes to the user's digital footprint. Online applications typically ask for more and more personal information than is strictly necessary to provide the service. Furthermore, many services are not transparent about their retention, storage, sharing, and purging policies. In many cases, these policies are included in a densely-worded end-user license agreement (EULA) that is incomprehensible to a user who is not legally trained. As a user signs up for more and more accounts and shares more and more data, the growing digital footprint of the user poses a threat to the user's digital privacy. Without a comprehensive way to track and recover accounts and data, the risk remains.

The present specification provides a novel mechanism of following various digital trails left by online accounts to discover and identify a user's online accounts based on the user's activity. In discovering these accounts, the system can also discover the user's digital exhaust (i.e., personal data shared that is no longer in the control of the user) for each online account. This can help to establish the user's total digital footprint. When online accounts are discovered and corresponding digital footprint has been identified, the system and method described herein identifies accounts that are not actively used by the user and thus pose a higher risk for compromise. The system also provides a novel, privacy-aware, pre-curation mechanism to help the user reclaim private data from online accounts.

In an embodiment, the system described provides account and context detection. The system may use a distributed collection of online activity scanners that can scan and locally process the current and historical data associated with a user. These data may be used to discover the user's accounts and the context of those accounts. Advantageously, at least some embodiments provide privacy-aware processing of user data to ensure that the user's private and sensitive information do not leave the user's device.

Based on this account detection, the system discovers or deduces the user's personal digital exhaust. This may include discovering the user's personal digital information shared with each account and identifying how each account contributes to the user's personal digital exhaust.

In embodiments, the system may also compute periodicity and diminishing interest. Determining the periodicity for each account and classifying the periodicity may be used to classify the account as either active or dormant. This periodicity may be based on multiple factors. For example, if a user interacts with a service on a daily or weekly basis, then, in most cases, that account will be considered active. However, some accounts do not require regular interaction. For example, an account used for filing income taxes may be accessed only once a year. Thus, the periodicity computation can contextually account for the user's history of interaction as well as ongoing interaction.

When stale accounts are identified, the system may also provide a remediation workflow. This could include determining account-specific workflows to enable users to reclaim their account and shared personal data.

In general, this system provides a privacy-aware and distributed mechanism of discovering user digital accounts by following various digital trails. It also provides a privacy-aware mechanism of identifying if the discovered account is active or dormant. It also provides a privacy-aware, pre-curation mechanism of identifying ways to reclaim data from each of the accounts.

This system realizes advantages over certain existing solutions. For example, some existing systems provide email-based account discovery. However, an email-only scanner may lack a complete view of all user accounts. Furthermore, these services may be inadequate in protecting user privacy. For example, these services may require nonlimiting permissions from the user and may have access to all the personal and sensitive email data of the user. Furthermore, at least some existing systems provide only rudimentary detection of digital exhaust. These systems may not account for the dynamic nature of services or for the dynamic nature of periodicity. Furthermore, the remediation mechanisms provided by these systems may be relatively narrow and may not consider all available options for reclaiming account information.

The system described herein realizes advantages by providing a novel, distributed mechanism of following various digital trails to discover a user's accounts. This solution need not rely on any one mechanism and protects the user's privacy by restricting permission and by performing local processing that filter out privacy-sensitive information from processing. In embodiments where data are sent to a cloud server for further analysis, these may not be the full raw data from the user, which may compromise the user's privacy, but rather may include only curated or contextual data that preserve the user's privacy. For example, rather than sending entire emails or messages to a cloud service, the system may provide only email headers or metadata about messages. This system also uses dynamic and online application-specific mechanisms to discover digital exhaust and includes a pre-curation approach that enables smoother reclaim of user data. The foregoing can be used to build or embody several example implementations, according to the teachings of the present specification. Some example implementations are included here as nonlimiting illustrations of these teachings.

A system and method for remediation of stale online accounts and digital exhaust will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

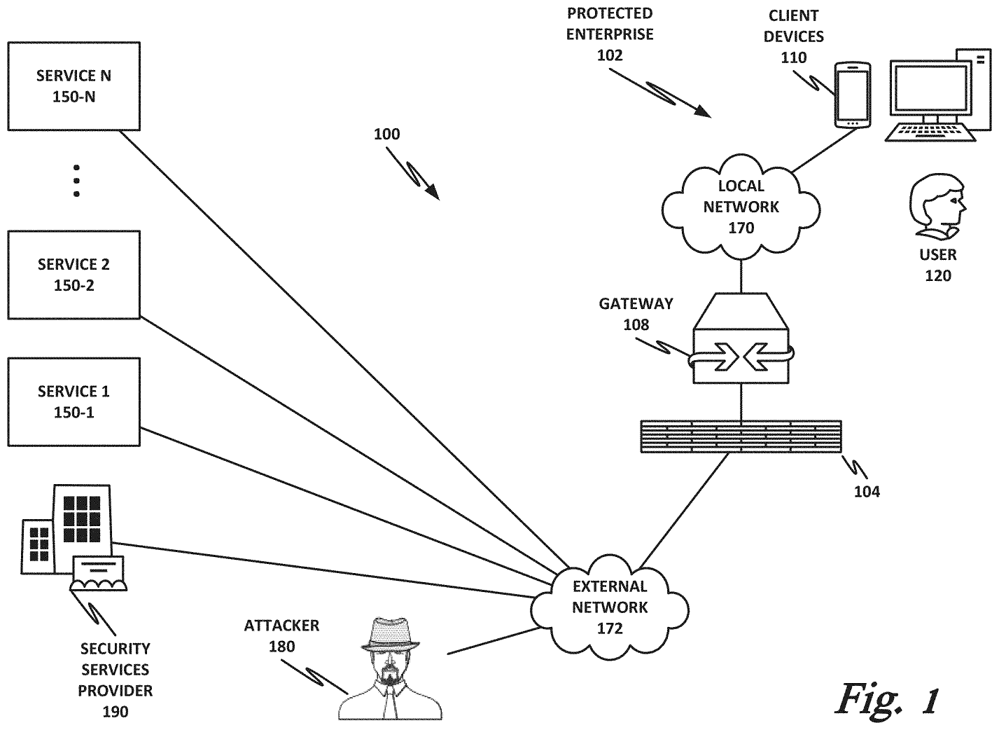

FIG. 1 is a block diagram of a security ecosystem 100. In the example of FIG. 1, security ecosystem 100 may be an enterprise, a government entity, a data center, a telecommunications provider, a “smart home” with computers, smart phones, and various internet of things (IoT) devices, or any other suitable ecosystem. Security ecosystem 100 is provided herein as an illustrative and nonlimiting example of a system that may employ, and benefit from, the teachings of the present specification.

Security ecosystem 100 may include one or more protected enterprises 102. A single protected enterprise 102 is illustrated here for simplicity, and could be a business enterprise, a government entity, a family, a nonprofit organization, a church, or any other organization that may subscribe to security services provided, for example, by security services provider 190.

Within security ecosystem 100, one or more users 120 operate one or more client devices 110. A single user 120 and single client device 110 are illustrated here for simplicity, but a home or enterprise may have multiple users, each of which may have multiple devices, such as desktop computers, laptop computers, smart phones, tablets, hybrids, or similar.

Client devices 110 may be communicatively coupled to one another and to other network resources via local network 170. Local network 170 may be any suitable network or combination of one or more networks operating on one or more suitable networking protocols, including a local area network, a home network, an intranet, a virtual network, a wide area network, a wireless network, a cellular network, or the internet (optionally accessed via a proxy, virtual machine, or other similar security mechanism) by way of nonlimiting example. Local network 170 may also include one or more servers, firewalls, routers, switches, security appliances, antivirus servers, or other network devices, which may be single-purpose appliances, virtual machines, containers, or functions. Some functions may be provided on client devices 110.

In this illustration, local network 170 is shown as a single network for simplicity, but in some embodiments, local network 170 may include any number of networks, such as one or more intranets connected to the internet. Local network 170 may also provide access to an external network, such as the internet, via external network 172. External network 172 may similarly be any suitable type of network.

Local network 170 may connect to the internet via gateway 108, which may be responsible, among other things, for providing a logical boundary between local network 170 and external network 172. Local network 170 may also provide services such as dynamic host configuration protocol (DHCP), gateway services, router services, and switching services, and may act as a security portal across local boundary 104.

In some embodiments, gateway 108 could be a simple home router, or could be a sophisticated enterprise infrastructure including routers, gateways, firewalls, security services, deep packet inspection, web servers, or other services.

In further embodiments, gateway 108 may be a standalone internet appliance. Such embodiments are popular in cases in which ecosystem 100 includes a home or small business. In other cases, gateway 108 may run as a virtual machine or in another virtualized manner. In larger enterprises that features service function chaining (SFC) or NFV, gateway 108 may be include one or more service functions and/or virtualized network functions.

Local network 170 may communicate across local boundary 104 with external network 172. Local boundary 104 may represent a physical, logical, or other boundary. User 120 may access, via gateway 108, certain services 150-1, 150-2, . . . 150-N. Services 150 may include, for example, websites, servers, network protocols, and other network-based services. In connection with accessing these services, user 120 may create accounts, such as email accounts, shopping accounts, free accounts, premium accounts, customer service accounts, or other accounts. In connection with these accounts, user 120 may share certain personal information. In sharing information with these accounts, the user may create a digital exhaust trail, and it is common for the user to forget which accounts were created when, and which data were shared with each account.

In one example, an attacker 180 (or other similar malicious or negligent actor) also connects to external network 172. It may be a goal of attacker 180 to compromise the security or personal data of user 120 or of devices 120. For example, attacker 180 may seek to access the digital exhaust of user 120. An effective way of denying attacker 180 access to the digital exhaust of user 120 is to eliminate the digital exhaust.

A security services provider 190 may provide services to local network 170, such as security software, security updates, network appliances, or similar. For example, MCAFEE, LLC provides a comprehensive suite of security services that may be used to protect local network 170 and the various devices connected to it.

It may be a goal of users 120 to successfully operate devices on local network 170 without interference from attacker 180, and without loss of personal data. One challenge for user 120 is that while they may control the security of their own device, they do not control the security of online services 150. Thus, any information shared with online services 150 may be compromised, and it out of the control of user 120.

Local network 170 may contract with or subscribe to a security services provider 190, which may provide security services, updates, antivirus definitions, patches, products, and services. MCAFEE, LLC is a nonlimiting example of such a security services provider that offers comprehensive security and antivirus solutions. In some cases, security services provider 190 may include a threat intelligence capability such as the global threat intelligence (GTI™) database provided by MCAFEE, LLC, or similar competing products. Security services provider 190 may update its threat intelligence database by analyzing new candidate malicious objects as they appear on client networks and characterizing them as malicious or benign.

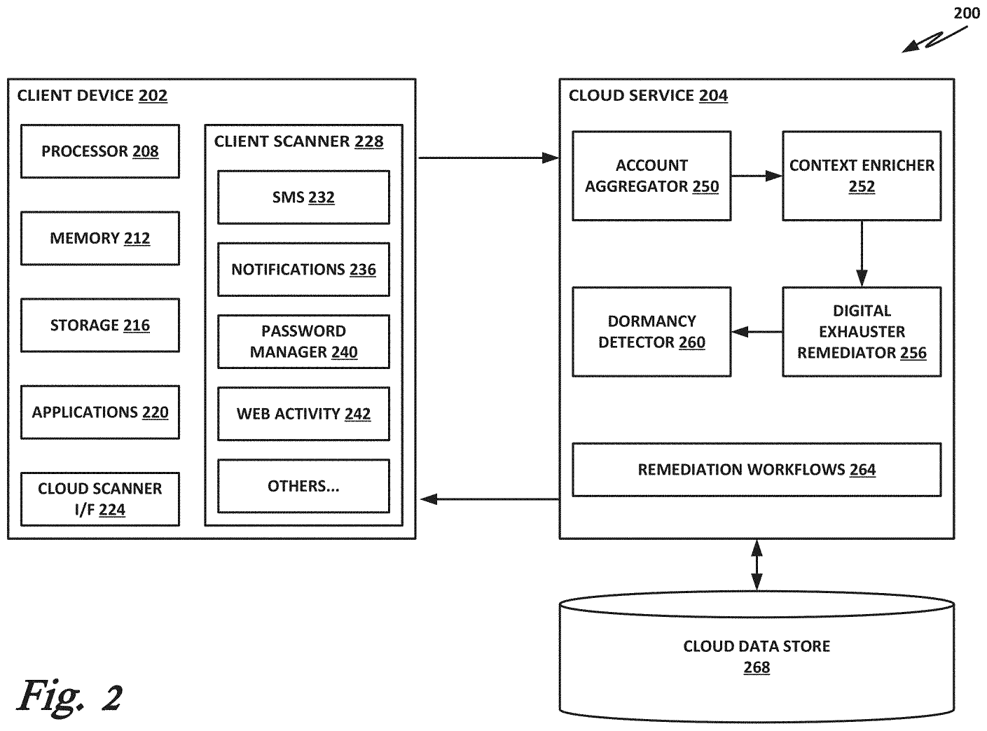

FIG. 2 is a block diagram of an account remediation ecosystem 200. Account remediation ecosystem 200 may be used to remediate online accounts for a user, and in particular, it may be used to discover and remediate stale accounts or zombie accounts.

A user's online activities may involve interactions with various web applications across multiple devices. The user may operate devices such as mobile smartphones, laptops, PCs, smart TVs, gaming consoles, and many others. Via these devices, the user may interact with certain online applications, such as to engage in commerce, control smart home IoT devices, view entertainment content, access educational resources, play games, surf the internet, communicate with friends and family, and many other activities. Many of these activities may involve online applications that request or require the user to create an online account. Thus, the user may generate many online accounts, such as one for each type of online activity or application that she interacts with.

When the user creates an online account with an online application, she may be required to provide her email address or phone number, and/or other personal, identifying, and/or private data. When the user interacts with the online application, the advertised reason for requiring email or mobile phone number may be to either identify the user or to enable a two-factor authentication. However, the application vendor may also monetize the user's details. These details may be used for sending product or application updates, providing account updates, providing account details, providing transaction alerts, newsletters, or other communications. In general, the user's interaction with the online application leaves some trail in the form of email, SMS, phone calls, notifications, web activities, password managers (including login credentials and/or autofill data), or similar.

Many online applications also collect the user's digital footprint data to monetize the data. Thus, the online application may lure the user into sharing more and more data. As the digital footprint gathered by these accounts grows, the user's exposure to accidental leakage or misuse of the digital footprint by bad actors may become a greater concern. This can lead to compromise of the user's privacy and to other personal or financial losses. For example, a leak of the user's Social Security number or other private data might result in identity theft, monetary loss, loss of reputation, loss of a job, or other.

Online account remediation system or ecosystem 200 may help to mitigate these dangers. In this illustrative example, the online account remediation ecosystem includes an end-user client device 202 and a cloud service 204, which accesses a cloud-based data store 268. This represents a high-level architecture that can be used to follow a user's digital account trail to discover and identify the user's online accounts. Note that the cloud-based scanners within cloud service 204 are provided by way of illustrative and nonlimiting example. They do not necessarily have to be on the cloud or even on a device separate from client device 202. In some examples, all of the functionality of ecosystem 200 may be provided locally on client device 202. Furthermore, in examples where the workload is divided between a client device and a cloud or other remote service, the division of services need not be as illustrated here. Other divisions of services can also be used.

Ecosystem 200 may use a distributed set of scanners and privacy-aware processing to discover user accounts, identify whether accounts are active or dormant, and help the user reclaim his data from the accounts. In some of the examples below, email and SMS trails are used as an example to illustrate the operative principles of the present specification. However, other scanners may be used, as described herein.

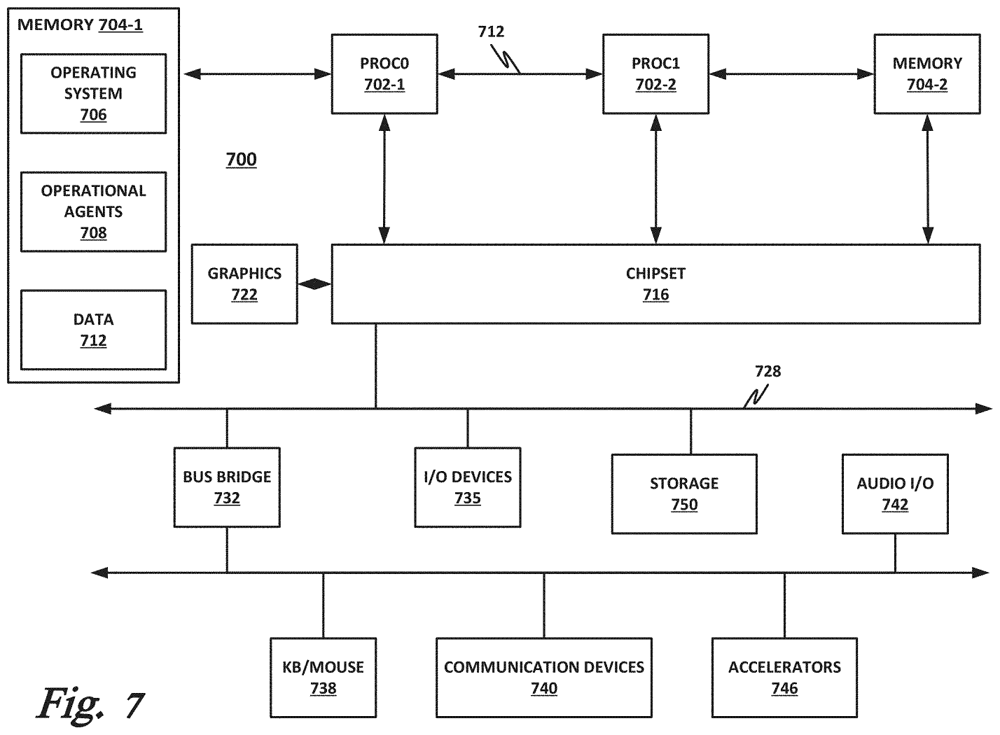

Client device 202 is based on a hardware platform that includes a processor 208 and a memory 212. Examples of additional details of a hardware platform are illustrated in FIGS. 7, 8 and 9 below, and those examples may be used in appropriate circumstances. Notably, processor 208 and memory 212 could be virtualized resources or could otherwise be based on a virtualization or guest infrastructure. However, even in the case of a virtual processor, the logical processor function ultimately maps to a hardware processor and hardware memory at some point in the processing infrastructure. Client device 202 also includes a storage 216, and there may be stored thereon, or within memory 212, a number of applications 220.

Client device 202 includes a client scanner 228, which may be a software module, for example. In the case of software, client scanner 228 may include executable instructions stored on storage 216 that may be loaded into memory 212 and executed by processor 208. Furthermore, in some examples, memory 212 and storage 216 may be a unitary memory. These instructions, when executed, provide certain software functions, modules, and/or engines as described in this specification and throughout the appended claims.

Client scanner 228 may include a number of distributed scanners, each responsible for collecting and scanning and locally processing one or more digital trails to discover user online accounts. These online account scanners scan their respective digital trails, which may include, by way of illustrative and nonlimiting example, short messaging service (SMS), email, email headers, stored password (which may include both login information and autofill data), web activities, browser logs, phone logs, and/or internet chat services such as Jabber, IRC, ICQ, XMPP, Slack, Nextcloud, ownCloud or others. These scanners may distinguish personal, marketing, and account-related items. For example, a scanner may have an ability, such as via a process or machine-learning (ML) model, to distinguish personal, marketing, and account-related activities using various features. These features can include, for example, known senders, name and email address, interaction periodicity, communication type, and others. In some cases, to preserve user privacy, a scanner may scan only metadata, such as email headers or metadata about transactions, such as sender, receiver, and time of the message. The content of the message or email may be omitted from the scanner to help preserve user privacy. Furthermore, even in cases where the content of messages is scanned locally, all such personal information may remain on the local device and be barred from being exported, such as being sent to a cloud service.

In some examples, client scanner 228 may have access to a reputation service, such as McAfee GTI or similar. This reputation service may be used to classify various URLs or other resources to determine the nature of emails, messages, and other activity.

In this illustration, client scanners 228 include SMS 232, a notification subsystem scanner 236, a password manager 240, web activity 242, and other scanners as appropriate to the application. These scanners may be used to identify context for account-related items. As described above, the scanners may analyze only account-related items to identify interaction context. In an example, interaction context may include unique account names. For example, account update, password resets, new logins, or others may be identified via subject lines or order/booking status from emails or messages on messaging services. The web browser history may also be used to identify login activity or stored account login information, such as via stored password, autofill data, and similar. All of these may be used to help identify whether a user has an account with a particular service. Correlation with a service such as GTI may help to identify which communications or activities represent digital account activity for the user.

A service such as GTI may also be used to identify the type of account or accounts that the user has. For example, accounts may be classified into certain categories such as online shopping, food ordering, travel, communication, education, work, news, entertainment, or others. These may be verified by an intelligence engine in a cloud service or may also be inferred via the context of messages. For example, email headers may be used to identify booking, tickets, orders, reservations, reservation confirmations, or other messages without inspecting the email content.

Client scanners 228 may also use historical analysis to identify the frequency or periodicity with which the user interacts with the service. For example, some services the users may interact with daily, while others may interact with on a weekly, biweekly, monthly, yearly, or other schedule. Client scanners 228 may access SMS or email or web activities related to each unique sender. In some cases, SMS, email, or other may be used to identify second-factor authentication prompts for logins. For example, a password reset email or one-time password (OTP) may be identified and correlated to active account use. A password manager log may also provide historical intervals of password updates for each unique sender.

To maintain user privacy, these data may be subject to local, on-device processing. The scanners may preprocess and analyze digital trails on the client device itself. The raw data about the user may not be sent to the cloud service, but rather derived intelligence (such as account and context) may be uploaded to a cloud service. This can help to protect the user's personal and sensitive information and help to prevent that information from leaving the user's device. Even from non-personal or non-identifying information, sensitive information like ordering or booking details, travel dates, or others may not be used in the cloud analysis and need not leave the user device. In an embodiment, only the minimal necessary permissions are used for client scanners 228. For example, in the case of an email scanner, the scanner may access only email headers, such as sender, receiver, subject, and date. The scanner need not access the message body. This limits exposure of the user's privacy-sensitive information, and prevents the information from reaching even the local scanner when the local scanner does not need the information to provide its intelligence. As described above, certain limited information, such as derived intelligence and account context, may be sent from client device 202 via cloud scanner interface 224 to a cloud-based analysis engine posted on cloud service 204. Cloud scanner interface 224 may provide, for example, an API or other logical interface to access cloud services.

Cloud service 204 may combine inputs from various kinds of digital trails (e.g., email, SMS, password managers, web activity, and others) and correlate these events to identify unique online services. Cloud service 204 may confirm the presence of user accounts for those online applications. In some embodiments, cloud service 204 may also remove related or duplicate accounts and aggregate context, such as interaction patterns, communication types, and others.

For example, in the example of FIG. 2, cloud service 204 may identify three one-way communications from the e-commerce website “OnlineShoppingMart” in one week. However, cloud service 204 may not be able to identify any other details about these interactions. A web activity scanner may also identify a login attempt on OnlineShoppingMart using a mobile number and an OTP for the same user at the beginning of the same week. These data can be provided by client device 202 to cloud service 204. Cloud service 204 may process these data via account aggregator engine 250 and confirm that the user has an account and that the communications were not a marketing campaign. Account aggregator 250 may also determine that the user shared a phone number with the OnlineShoppingMart website. Account aggregator 250 may also determine that the user received three communications in one week.

Context enrichment 252 may then be used to perform services such as improving categorization, identifying applications and user relevance, and identifying locations and governing law.

Digital exhaust remediator 256 may then be used to identify the user's digital exhaust and categorize the information provided by the user.

Dormancy detector 260 may then be used to determine whether the account is dormant.

Remediation workflows 264 can then be applied to dormant, stale, or zombie accounts to provide policies or activities that may be executed to remediate the user's digital exhaust for certain accounts. In some cases, this can be done directly by cloud service 204, such as by cloud service 204, sending appropriate emails or other messages to cancel user accounts, and request deletion of the user data. Optionally, cloud service 204 may query user via client device 202 before deleting accounts to receive a confirmation that accounts are to be deleted.

Cloud service 204 provides remediation workflows 264. Remediation workflows 264 may provide an application-specific mechanism. This engine may discover application-specific mechanisms to reclaim online accounts and corresponding digital exhaust. For applications that support a data-erasure request from the registered user, the engine may use support emails identified during context enrichment to automatically send reclamation emails on the user's behalf.

Note, however, that the privacy-aware email scanner may not read an email body. Thus, there may be challenges in understanding an online application's response to a data-erasure request. Thus, in some embodiments, the system provides pre-curation of such requests. To overcome the privacy challenge, the engine may use a privacy-aware human-machine teaming approach to pre-curate account reclamation steps. For example, the system may create a dummy account and then send a data-erasure email for the dummy account. The system can then process the response. Because the email is sent to the system and not to an end-user, the system can learn the context of the response email without compromising user privacy when a real account is encountered.

The remediation workflow may thus create accounts in each of the discovered online applications and automatically send data-erasure requests. Remediation workflow engine 264 may then use natural language processing techniques to analyze the response and determine if the request was successful, rejected, if more information was requested, or there was a suggestion to use an online or in-app option.

For accounts where reclamation was rejected or more information was requested, a human operator may help to appropriately determine next steps.

For accounts offering a reclamation mechanism via an in-app or online request, remediation workflow engine 264 may provide back to client device 202 as an option to reclaim the mechanism via an in-app request. This solution may guide the user through the process of making the request. In some cases, where an appropriate API is provided, remediation workflow engine 264 may provide appropriate instructions to client device 202. In many use cases, it is appropriate to query the user for confirmation before deleting accounts, either automatically or manually.

In some cases, it is not possible for cloud service 204 to automatically delete every account. Some account deletions require human interaction. Thus, cloud service 204 may partner with human actors who can perform some of the human intervention steps with the permission and verification of the end-user. In other cases, cloud service 204 provides to the user, via client device 202, instructions for deleting accounts, such as via websites or apps provided by the account providers.

Furthermore, even in cases where it is possible to delete an account autonomously from the cloud service, it may be desirable to give the user an opportunity to confirm that the account should be deleted. To make the confirmation and delete process simple for the end-user, the endpoint device may include a software interface (such as a graphical user interface (GUI)) that provides a one-click option. For example, the GUI may display to the user accounts that have been identified as being potentially stale, and next to each listed account, there may be a button or other UI element with a label like “Delete,” “Reclaim,” or similar. When the user clicks or interacts with this UI elements, an instruction may be sent to the cloud service to delete or reclaim the account. In an example, the system described herein may perform all necessary steps on behalf of the user. Alternatively, the system may perform those steps that it is able to perform. For example, the user may be provided with instructions to login to a service, go to a particular place on the website, and perform certain actions. If the user is already logged in, the system may be able to perform all of these actions autonomously on the user's behalf. Alternatively, if the user is not logged in, the user may be prompted to login to the website, and the system may then perform the necessary steps.

Optionally, the GUI may request a second confirmation (e.g., “Delete Account for StaleOnlineAccount.com?”). This may be configurable as a user option, where true one-click operation is achieved by omitting the second confirmation.

Cloud service 204 may also have access to a cloud data store 268, which can be used to train ML models, aggregate data from many different users, and provide other global views of data.

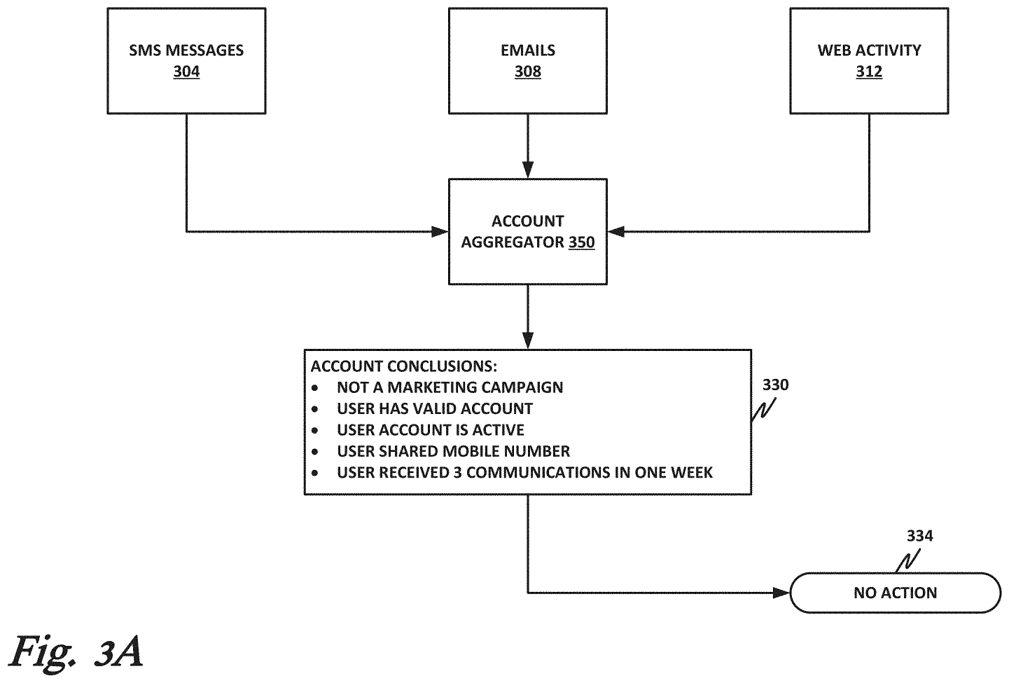

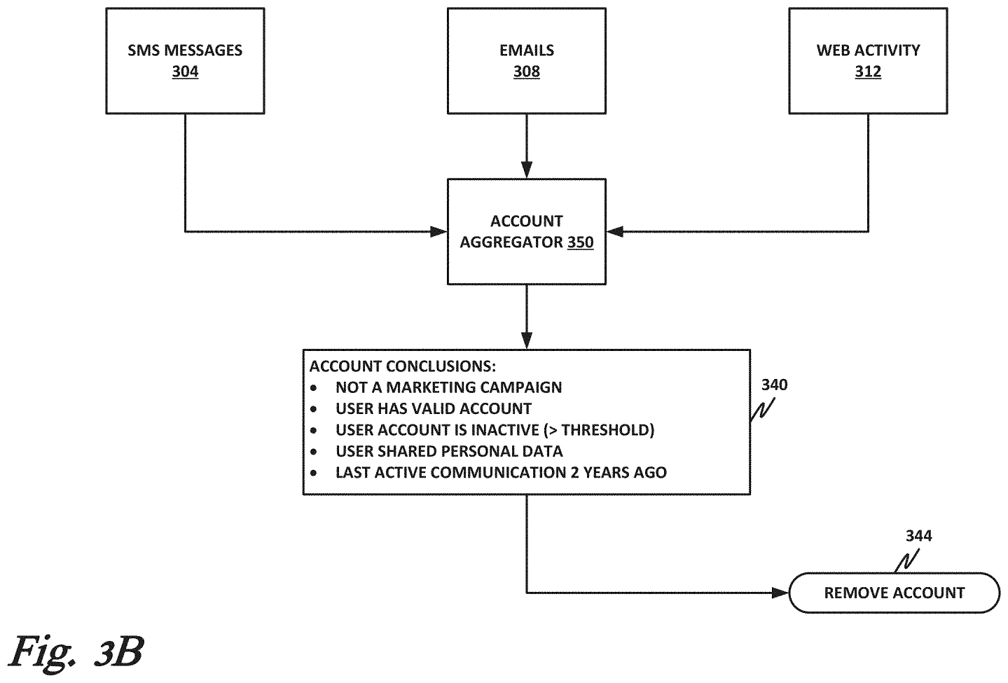

FIGS. 3A and 3B represent a block diagram of selected elements of an account aggregator 350. Account aggregator may be, for example, an embodiment of account aggregator 250 of FIG. 2.

Account aggregator 350 combines inputs from various kinds of digital trails, such as SMS messages 304, emails 308, web activity 312, and other account scanners. Account aggregator 350 then correlates these events to identify unique online services and confirms the presence of user accounts for that online application.

FIGS. 3A and 3B illustrate different conclusions that may be drawn by account aggregator 350 based on different user inputs.

In the example of FIG. 3A, account aggregator 350 determines (e.g., in conclusions 330) from inputs provided by online account scanners that communication from an online service does not represent a marketing campaign, but instead, the user has a valid account with that online service. Account aggregator 350 may also determine that the account is active. In this case, the user has shared a mobile number with the online account, such as to provide two-factor authentication. The user may have also provided other personal information, such as home address, work address, additional phone numbers, email addresses, date of birth, social media connections, and others. In this example, the user received three communications from the service in a one week period.

Account aggregator 350 uses a rules-based approach or a ML algorithm to consume these inputs. Account aggregator 350 may also account for periodicity in the user's interaction. For example, some users will interact with some types of accounts more frequently than with other types of accounts.

In the example of FIG. 3A, because the user has an active account and is actively communicating with that account, in block 334, no additional action needs to be taken.

FIG. 3B represents a different account activity result. In the example of FIG. 3B, the results of various online activity scanners may determine (e.g., in conclusions 340) that communications do not represent a marketing campaign and that the user has a valid account. However, account aggregator 350 may determine that the account is in active above a particular threshold, which may optionally account for periodicity. Account aggregator 350 may also determine that the user has shared personal data with the account and that the last active communication with the account was two years ago. Thus, in block 344, account aggregator 350 determines that the account is a candidate for removal.

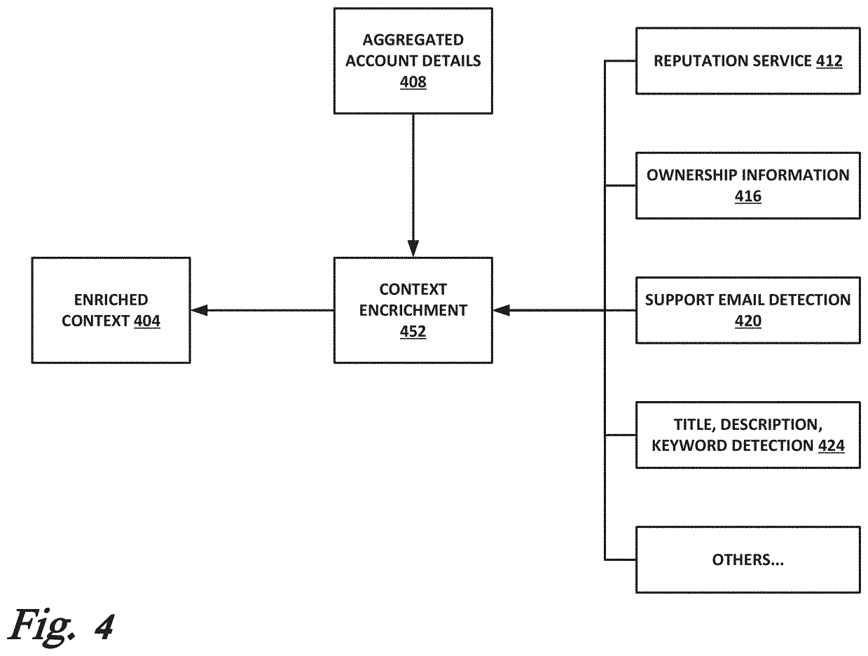

FIG. 4 is a block diagram of a context enrichment engine 452. Context enrichment engine 452 may be, for example, an embodiment of context enrichment 252 of FIG. 2. Context enrichment engine 452 may enrich account context through third-party sources. For example, context enrichment 452 may receive aggregated account details 408. These may be received, for example, from an account aggregator. This may include conclusions, such as whether the account is a marketing campaign, whether the user has an active account, which data the user has shared with the online account, and how frequently the user communicates with the account, among others. Context enrichment engine 452 may also receive third-party inputs, such as from a reputation service 412. Reputation service 412 may be a service that provides reputations or metadata for URL or other identifiers for account services. For example, McAfee GTI provides such services.

Context enrichment engine 452 may also receive ownership information 416 from various sources, such as from a WHOIS database. In some cases, context enrichment engine 452 may also provide an engine to do support email detection as in block 420. In block 424, context enrichment engine 452 may also receive a title, description, or keyword detection.

Context enrichment engine 452 helps to detect a user's digital exhaust. Digital exhaust may include any personal digital assets that a user has shared with online applications. Examples include identity such as name, email, mobile phone number, Social Security number, or others. It may also include financial information such as account details, credit card details, account balances, account numbers, routing numbers, or others. It may also include data such as date of birth, address, social status, or similar. It may also include behavioral data such as likes, dislikes, hobbies, interests, religious or political views, or others. Context enrichment engine 452 may use ML models trained on various data sources to identify a user's digital exhaust. For example, there is described above a use case in which a user has an account with OnlineShoppingMart. In the case of this example, the user's identity, such as name and mobile phone number, may have been shared with the online service. Analyzing a privacy policy document provided by the online service provider, the system may also determine that OnlineShoppingMart collects location data, such as IP address and postal address, behavioral data, such as pages viewed, user behavior patterns, number of sessions, unique visitors, and browsing activities, and financial data, such as bank accounts and account numbers.

Context enrichment 452 may also detect diminishing user interest to help qualify an account as dormant or stale. The engine may use the account type and historical frequency of interaction to identify a diminishing user's interest. For example, if an online shopping account was used a few times a month a couple of years back and was last used over a year ago, this shows that the user is no longer actively interacting with the online shopping account. Thus, the account may be categorized as dormant or stale.

Context enrichment 452 may also consider typical periodicity of an account usage based on its type. For example, a user's government ID accounts like driver's license, passport, or similar may be required to renew or update those government services but may be used only annually or even only once every few years. Similarly, government tax accounts are typically needed to be accessed approximately once a year at tax time. Thus, the active or dormant detection may vary with periodicity and account type.

Context enrichment engine 452 may dynamically assign thresholds to diminishing interest based on account types and periodicity. For example, with the OnlineShoppingMart example above, the enriched context indicates that the OnlineShoppingMart account typically does not have much activity after a few weeks unless there is a new product request. The engine may consider the lack of activity as an indication of diminishing interest. In this case, if the engine does not see new activity from the user for over a year, or some other threshold, the system may identify the account as dormant.

As an output, context enrichment engine 452 provides enriched context 404.

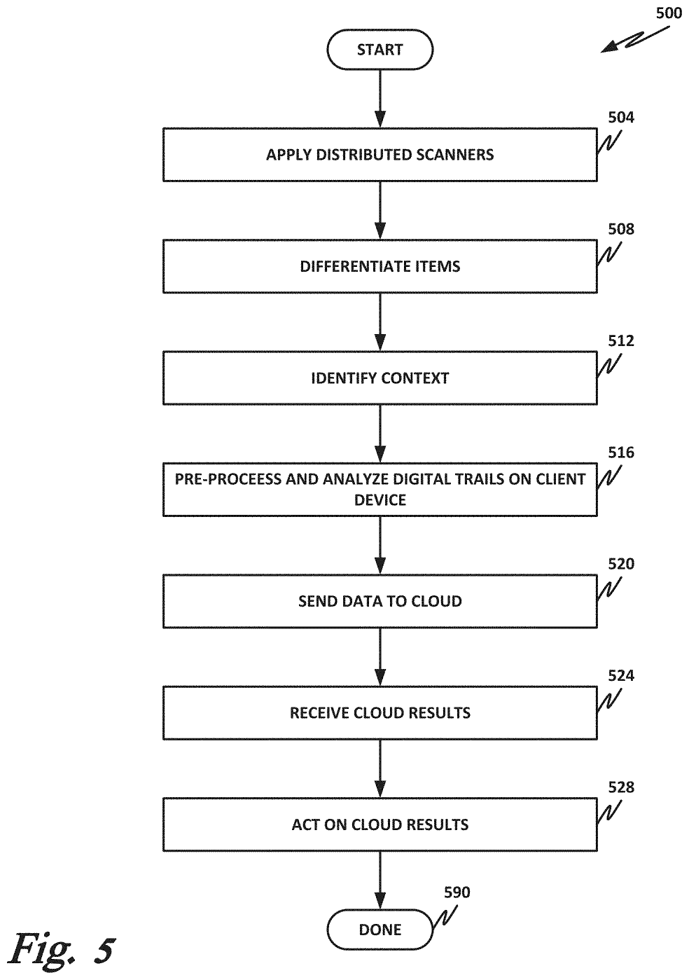

FIG. 5 is a flowchart of a method 500. Method 500 may be performed, for example, by an end-user client device according to the teachings of the present specification. Method 500 may also be performed by any other appropriate device.

In block 504, the system may apply appropriate distributed scanners, such as those disclosed in connection with client scanner 228 of FIG. 2. Note that those scanners are provided as illustrative and nonlimiting examples only, and other scanners may be provided. As illustrated in connection with FIG. 2, these scanners may be configured in at least some embodiments to help ensure and protect user privacy.

In block 508, the scanners may differentiate items, such as by distinguishing personal, marketing, and account-related messages from among those discovered by the scanners.

In block 512, the engine may identify the context for each account identified. This may include identifying unique account names, and classifying the accounts according to the account type. This may also include detecting the periodicity of interaction with the accounts.

In block 516, the client engine may preprocess and analyze digital trails on the client device. This may provide certain derived intelligence that does not compromise or that minimally compromises the user's personal data. Thus, rather than sending the user's data to the cloud wholesale, only those data necessary to provide the functions described herein may be sent.

In block 520, the client engine sends appropriate data to the cloud for further analysis. As discussed above in connection with FIG. 2, these data may include data derived from local processing, and thus may exclude sending private or personally-identifying information to the cloud.

In block 524, the client engine may receive the results of the cloud analysis, which may also include appropriate recommendations, such as instructions for deleting or otherwise remediating certain accounts.

In block 528, the client device may autonomously act out instructions provided by the cloud service or it may provide instructions to the end-user to act on those instructions.

In block 590, the method is done.

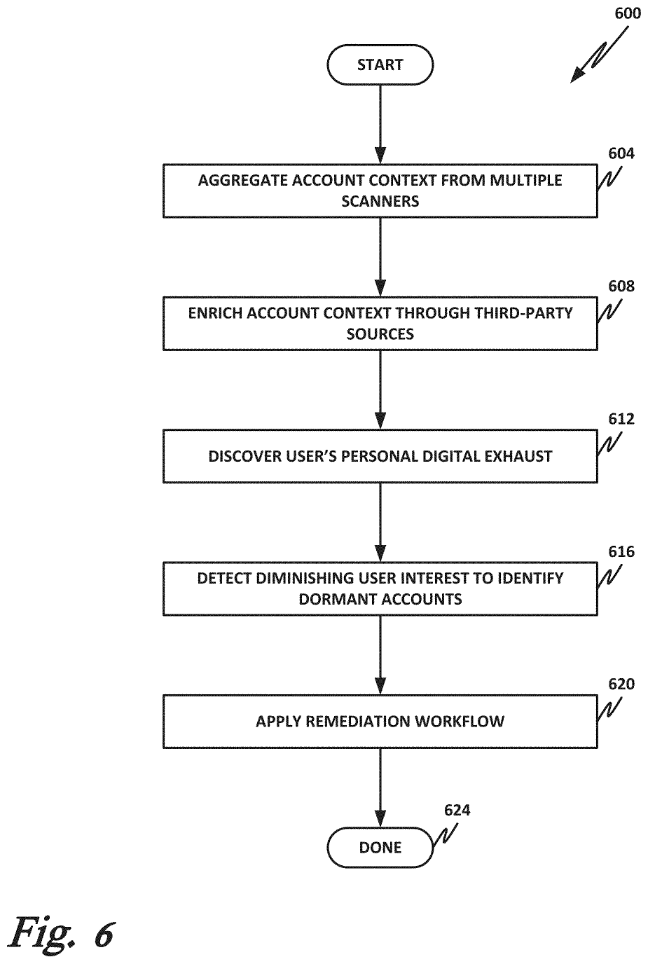

FIG. 6 is a flowchart of a method 600 performed by a cloud data service. Notably, the division of work between method 500 and 600 is provided by way of illustrative and nonlimiting example only. Furthermore, while method 600 may be performed on a cloud-based device, it may also be performed on any other appropriate device, including on the same end-user device that performs method 500.

Starting in block 604, the cloud service aggregates account context for multiple scanners, as illustrated in more detail in account aggregator 250 of FIG. 2 and account aggregator 350 of FIGS. 3A and 3B. Those can be used to identify and classify the account and aggregate data about the account.

In block 608, the cloud service may enrich the account context through third-party sources and other analysis, such as ML analysis. An example of this is described in greater detail in connection with FIG. 4.

In block 612, according to the analysis performed, the cloud service may detect or estimate the user's personal digital exhaust, according to the accounts identified and the information that has been or that may have been shared with those accounts.

In block 616, the cloud service may also detect diminishing user interests to identify dormant, stale, or zombie accounts. This may account for periodicity or for other factors that affect the frequency with which the user interacts with accounts.

In block 620, once dormant or stale accounts have been identified, the cloud service may apply a remediation workflow to each dormant or stale account. In some cases, this includes performing account deletion from the cloud service itself, optionally, after acquiring a user for confirmation to delete the account. In other cases, where it is not practical for the cloud service to autonomously delete the account, the remediation workflow may include providing instructions to the end-user device or to the user via the end-user device to delete those accounts from the end-user device or from a web browser.

In block 624, the method is done.

FIG. 7 is a block diagram of a hardware platform 700. Hardware platform 700 may provide hardware for an end-user device such as device 110 of FIG. 1, gateway 108, client device 202 of FIG. 2, cloud service 204, and/or cloud data storage 268, by way of nonlimiting example.

Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 700, even though they may be scattered across a data center, or even located in different data centers.

Hardware platform 700 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 700 is arranged in a point-to-point (PtP) configuration. This PtP configuration is popular for personal computer (PC) and server-type devices, although it is not so limited, and any other bus type may be used.

Hardware platform 700 is an example of a platform that may be used to implement embodiments of the teachings of this specification. For example, instructions could be stored in storage 750. Instructions could also be transmitted to the hardware platform in an ethereal form, such as via a network interface, or retrieved from another source via any suitable interconnect. Once received (from any source), the instructions may be loaded into memory 704, and may then be executed by one or more processor 702 to provide elements such as an operating system 706, operational agents 708, or data 712.

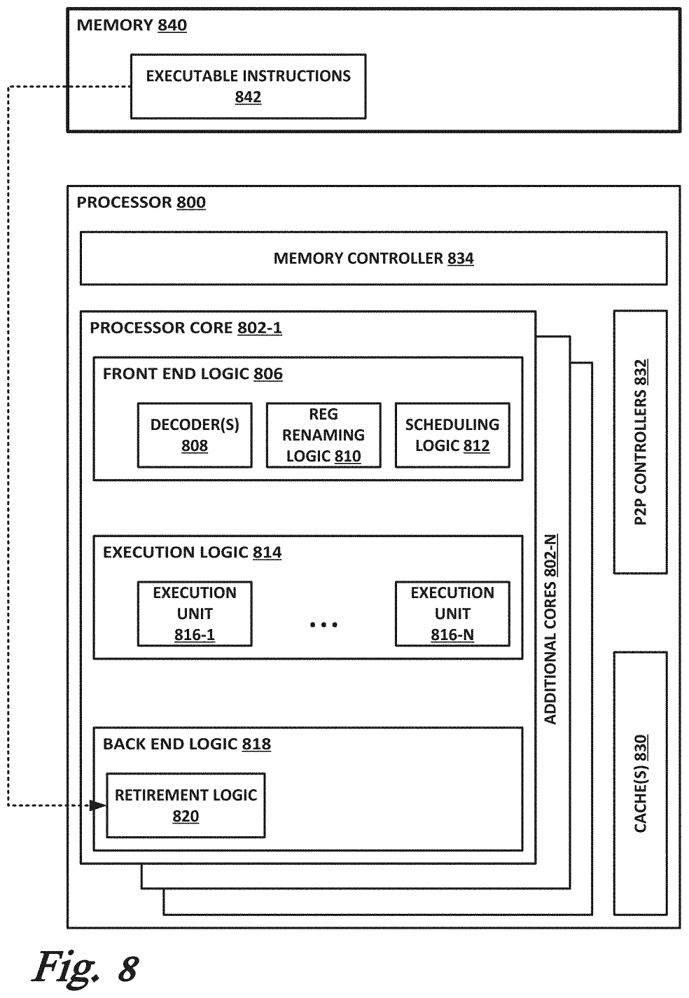

Hardware platform 700 may include several processors 702. For simplicity and clarity, only processors PROC0 702-1 and PROC1 702-2 are shown. Additional processors (such as 2, 4, 8, 16, 24, 32, 64, or 128 processors) may be provided as necessary, while in other embodiments, only one processor may be provided. Details of processors 702 are not illustrated in this FIGURE, but one embodiment is illustrated in FIG. 8. Processors may have any number of cores, such as 1, 2, 4, 8, 16, 24, 32, 64, or 128 cores.

Processors 702 may be any type of processor and may communicatively couple to chipset 716 via, for example, PtP interfaces. Chipset 716 may also exchange data with other elements, such as a high performance graphics adapter 722. In alternative embodiments, any or all of the PtP links illustrated in FIG. 7 could be implemented as any type of bus, or other configuration rather than a PtP link. In various embodiments, chipset 716 may reside on the same die or package as a processor 702 or on one or more different dies or packages. Each chipset may support any suitable number of processors 702. A chipset 716 (which may be a chipset, uncore, Northbridge, Southbridge, or other suitable logic and circuitry) may also include one or more controllers to couple other components to one or more CPUs.

Two memories, 704-1 and 704-2 are shown, connected to PROC0 702-1 and PROC1 702-2, respectively. As an example, each processor is shown connected to its memory in a direct memory access (DMA) configuration, though other memory architectures are possible, including ones in which memory 704 communicates with a processor 702 via a bus. For example, some memories may be connected via a system bus, or in a data center, memory may be accessible in a remote DMA (RDMA) configuration.

Memory 704 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 704 may be used for short, medium, and/or long-term storage. Memory 704 may store any suitable data or information utilized by platform logic. In some embodiments, memory 704 may also comprise storage for instructions that may be executed by the cores of processors 702 or other processing elements (e.g., logic resident on chipsets 716) to provide functionality.

In certain embodiments, memory 704 may comprise a relatively low-latency volatile main memory, while storage 750 may comprise a relatively higher-latency nonvolatile memory. However, memory 704 and storage 750 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 704 and storage 750, for example, in a single physical memory device, and in other cases, memory 704 and/or storage 750 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 722 may be configured to provide a human-readable visual output, such as a command-line interface or graphical desktop such as Microsoft Windows, Apple OSX desktop, or a Unix/Linux X Window System-based desktop. Graphics adapter 722 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 722 may include a hardware graphics card, which may have its own memory and its own graphics processing unit (GPU).

Chipset 716 may be in communication with a bus 728 via an interface circuit. Bus 728 may have one or more devices that communicate over it, such as a bus bridge 732, I/O devices 735, accelerators 746, communication devices 740, and a keyboard and/or mouse 738, by way of nonlimiting example. In general terms, the elements of hardware platform 700 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 740 can broadly include any communication not covered by a network interface and the various I/O devices described herein. This may include, for example, various USB, FireWire, Lightning, or other serial or parallel devices that provide communications.

I/O Devices 735 may be configured to interface with any auxiliary device that connects to hardware platform 700 but that is not necessarily a part of the core architecture of hardware platform 700. A peripheral may be operable to provide extended functionality to hardware platform 700, and may or may not be wholly dependent on hardware platform 700. In some cases, a peripheral may be a computing device in its own right. Peripherals may include input and output devices such as displays, terminals, printers, keyboards, mice, modems, data ports (e.g., serial, parallel, universal serial bus (USB), Firewire, or similar), network controllers, optical media, external storage, sensors, transducers, actuators, controllers, data acquisition buses, cameras, microphones, speakers, or external storage, by way of nonlimiting example.

In one example, audio I/O 742 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 732 may be in communication with other devices such as a keyboard/mouse 738 (or other input devices such as a touch screen, trackball, etc.), communication devices 740 (such as modems, network interface devices, peripheral interfaces such as PCI or PCIe, or other types of communication devices that may communicate through a network), audio I/O 742, a data storage device 744, and/or accelerators 746. In alternative embodiments, any portions of the bus architectures could be implemented with one or more PtP links.

Operating system 706 may be, for example, Microsoft Windows, Linux, UNIX, Mac OS X, iOS, MS-DOS, or an embedded or real-time operating system (including embedded or real-time flavors of the foregoing). In some embodiments, a hardware platform 700 may function as a host platform for one or more guest systems that invoke application (e.g., operational agents 708).

Operational agents 708 may include one or more computing engines that may include one or more non-transitory computer-readable mediums having stored thereon executable instructions operable to instruct a processor to provide operational functions. At an appropriate time, such as upon booting hardware platform 700 or upon a command from operating system 706 or a user or security administrator, a processor 702 may retrieve a copy of the operational agent (or software portions thereof) from storage 750 and load it into memory 704. Processor 702 may then iteratively execute the instructions of operational agents 708 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 700 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QPI or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 700 may be virtualized, in particular the processor(s) and memory. For example, a virtualized environment may run on OS 706, or OS 706 could be replaced with a hypervisor or virtual machine manager. In this configuration, a virtual machine running on hardware platform 700 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 7 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 8 is a block diagram illustrating selected elements of a processor 800. In various examples, and throughout this specification and the appended claims, a “processor” includes (either directly, or indirectly via a virtualization or other layer) at least one logic gate. A processor may include any combination of logic elements operable to execute instructions, whether loaded from memory, or implemented directly in hardware, including, by way of nonlimiting example, a microprocessor, microcontroller, central processor unit (CPU), advanced RISC (reduced instruction set computing) machine (ARM), digital signal processor (DSP), FPGA, GPU, programmable logic array, ASIC, or virtual machine processor. In certain architectures, a multi-core processor may be provided, having for example, 2, 4, 8, 12, 16, 24, 32, 64, or 128 cores. In some embodiments, one or more co-processors or accelerators (hardware or software) may also be provided for specialized or support functions. In general, processor 800 may include any number of processing elements, which may be symmetrical or asymmetrical.

As used throughout this specification and the appended claims, a “hardware platform” identifies a genus of hardware devices, such as those commonly known as “von Neumann” machines. In general terms, a hardware platform includes at least one processor, and at least one memory. The memory may be split into volatile or main memory, and nonvolatile or slower memory that is used for storage. However, this split in-memory is not necessary, and in some hardware platforms, a single memory structure is used. The hardware platform genus includes a wide range of devices, spanning from single-purpose embedded computers running on ASIC, or running on a special purpose processor or DSP, and also includes devices such as smartphones, tablets, laptop computers, two-in-one computers, desktop computers, standalone servers, and various classes of enterprise or data center devices. These may include a virtualized infrastructure, wherein certain network functions are provided via NFV, and wherein the “computer” may be implemented as a virtual machine or a container running on a host architecture. This also includes so-called infrastructure as a service (IaaS), wherein devices may be provided in a disaggregated architecture. In the IaaS context, the processor, memory, storage, accelerators, and peripheral devices need not even be located on the same physical device. For example, in a disaggregated architecture, a processor may be provisioned from a processor bank, memory may be provisioned from a memory bank, storage may be provisioned from a storage bank, and accelerators may be provisioned from an accelerator bank. These may be connected only in the sense that they are connected by very fast networking interfaces, and may be located on the same server rack, or even on different server racks in different locations.

At some level, these various hardware platforms ultimately map to instructions executing on a hardware processor, or other processing circuit. On an ASIC, the instructions may be encoded into the hardware itself, whereas in a typical von Neumann machine, the instructions are loaded from a main memory. Even in a virtualized architecture, a virtualized memory location ultimately maps to a physical memory, and even in cases where multiple VMs are running on the same host hardware, the VM operating the algorithm of interest to a particular embodiment at some point takes ownership of a physical processor—even temporarily—and executes its instructions on that processor. Thus, the term hardware platform should be understood to broadly encompass any of these embodiments. In cases where a particular species of hardware architecture is intended, that hardware architecture may be identified more specifically, such as via terms like “smart phone” or “tablet.” Otherwise, it may be broadly understood that any computing apparatus of the present specification may run on any of the hardware platforms described herein.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

Processor 800 includes one or more processor cores 802, including core 802-1-802-N. Cores 802 may be, as appropriate, single-thread cores or multi-thread cores. In multithreaded cores, more than one hardware thread may be provided at a time, and the core may therefore provide more than one logical core per physical core. The cores may be configured to execute instruction code. Each processor 800 may include at least one shared cache 830, which may be treated logically as part of memory 840. Memory 840 may include executable instructions 842, as illustrated. Caches 830 may be filled according to known caching techniques, and may store instructions and/or data that may be used by one or more components of processor 800.

Processor 800 may include an integrated memory controller (MC) 834, to communicate with memory 840. Memory controller 834 may include logic and circuitry to interface with memory 840, and may also include a cache controller to handle filling and evicting instructions and data to and from cache 830.

By way of example, each core 802 may include front-end logic 806, execution logic 814, and backend logic 818.

In the illustrated embodiment, front-end logic 806 includes an instruction decoder or decoders 808, register renaming logic 810, and scheduling logic 812. Decoder 808 may decode instructions received. Register renaming logic 810 may provide register renaming, for example to facilitate pipelining. Scheduling logic 812 may schedule instruction execution, and may provide out-of-order (000) execution. Front-end logic 806 may fetch incoming instructions, perform various processing (e.g., caching, decoding, branch predicting, etc.), and pass instructions to execution logic 814.

Execution logic 814 includes one or more execution units 816-1-816-N. Execution units 816 may include hardware instructions and microcode to carry out the provided instructions.

Backend logic 818 includes retirement logic 820. Core 802 may provide for speculative execution of instructions, branch prediction, and similar. Retirement logic 820 may be configured to determine which predicted instructions were actually needed by the program flow.

Processor 800 may also include a PtP controller 832, which enables connection to an uncore, chipset, Northbridge, Southbridge, or bus, by way of example.

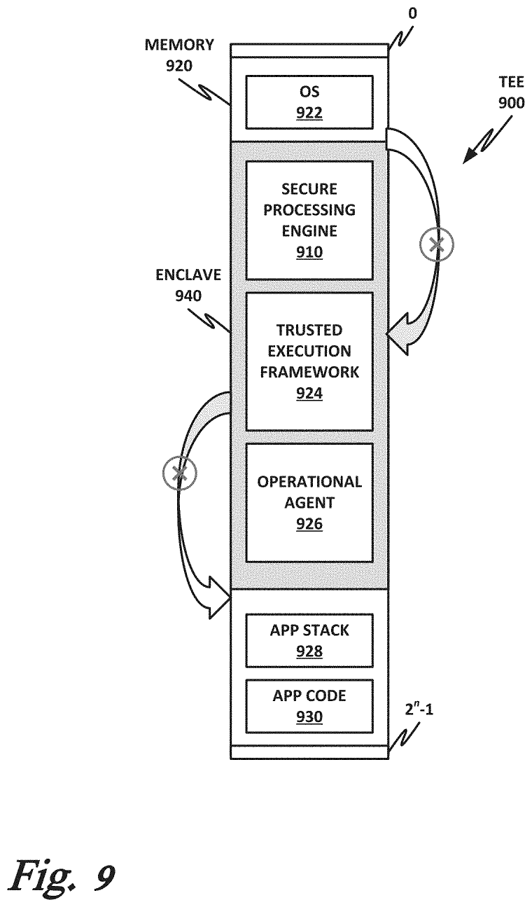

FIG. 9 is a block diagram of a TEE 900. TEE 900 may be used to provide electronically-secured communications between devices, such as attestation between a client device and a server device. Such secured communications can be used to verify content and ensure that communications have not been tampered with. For example, attestation such as direct anonymous attestation (DAA) may be used when a client device requests a reputation for an object, or an account action. This can help to ensure that the response is valid and trusted.

In the example of FIG. 9, memory 920 is addressable by n-bits, ranging in address from 0 to 2ⁿ−1 (note, however, that in many cases, the size of the address space may far exceed the actual memory available). Within memory 920 is an OS 922, enclave 940, application stack 920, and application code 930.

In this example, enclave 940 is a specially-designated portion of memory 920 that cannot be entered into or exited from except via special instructions, such as Intel Software Guard Extensions (SGX) or similar. Enclave 940 is provided as an example of a secure environment which, in conjunction with a secure processing engine 910, forms a TEE 900 on a hardware platform such as platform 700 of FIG. 7. A TEE 900 is a combination of hardware, software, and/or memory allocation that provides the ability to securely execute instructions without interference from outside processes, in a verifiable way. By way of example, TEE 900 may include memory enclave 940 or some other protected memory area, and a secure processing engine 910, which includes hardware, software, and instructions for accessing and operating on enclave 940. Nonlimiting examples of solutions that either are or that can provide a TEE include Intel SGX, ARM TrustZone, AMD Platform Security Processor, Kinibi, securiTEE, OP-TEE, TLK, T6, Open TEE, SierraTEE, CSE, VT-x, MemCore, Canary Island, Docker, and Smack. Thus, it should be noted that in an example, secure processing engine 910 may be a user-mode application that operates via trusted execution framework 924 within enclave 940. TEE 900 may also conceptually include processor instructions that secure processing engine 910 and trusted execution framework 924 require to operate within enclave 940.

Secure processing engine 910 and trusted execution framework 924 may together form a trusted computing base (TCB), which is a set of programs or computational units that are trusted to be secure. The TCB may include one or more operational agents 926, which carry out the desired functions of a program within the TCB. Conceptually, it may be advantageous to keep TCB relatively small so that there are fewer attack vectors for malware objects or for negligent software. Thus, for example, operating system 922 may be excluded from TCB, in addition to the regular application stack 928 and application code 930.

In certain systems, computing devices equipped with Intel SGX or equivalent instructions may be capable of providing an enclave 940. It should be noted, however, that many other examples of TEEs are available, and TEE 900 is provided only as one example thereof. Other secure environments may include, by way of nonlimiting example, a virtual machine, sandbox, testbed, test machine, or other similar device or method for providing a TEE 900.

In an example, enclave 940 provides a protected memory area that cannot be accessed or manipulated by ordinary computer instructions. Enclave 940 is described with particular reference to an Intel SGX enclave by way of example, but it is intended that enclave 940 encompass any secure processing area with suitable properties, regardless of whether it is called an “enclave.”

One feature of an enclave is that once an enclave region 940 of memory 920 is defined, as illustrated, a program pointer cannot enter or exit enclave 940 without the use of special enclave instructions or directives, such as those provided by Intel SGX architecture. For example, SGX™ processors provide the ENCLU[EENTER], ENCLU[ERESUME], and ENCLU[EEXIT]. These are the only instructions that may legitimately enter into or exit from enclave 940.

Thus, once enclave 940 is defined in-memory 704, a program executing within enclave 940 may be safely verified to not operate outside of its bounds. This security feature means that secure processing engine 910 is verifiably local to enclave 940. Thus, when an untrusted packet provides its content to be rendered with trusted execution framework 924 of enclave 940, the result of the rendering is verified as secure.

Enclave 940 may also digitally sign its output, which provides a verifiable means of ensuring that content has not been tampered with or modified since being rendered by secure processing engine 910. A digital signature provided by enclave 940 is unique to enclave 940 and is unique to the hardware of the device hosting enclave 940.

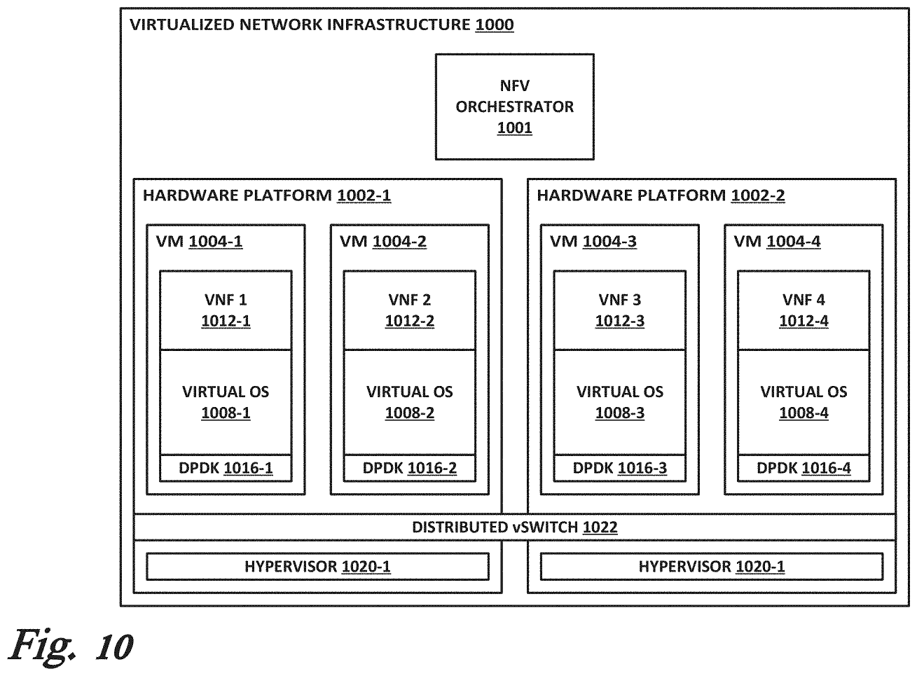

FIG. 10 is a block diagram of a NFV infrastructure 1000. NFV may be used to provide any of the devices or functions disclosed herein. Most commonly, server functions are provided within NFV, or via virtualization. For example within cloud service 204, any of the functions may be provided as a VNF or as a virtual machine. Workstations, desktops, and client devices are also sometimes provided via virtualization.

NFV is an aspect of network virtualization that is generally considered distinct from, but that can still interoperate with, software-defined networking (SDN). For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1000. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 10, an NFV orchestrator 1001 manages a number of the VNFs 1012 running on an NFVI 1000. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1001 a valuable system resource. Note that NFV orchestrator 1001 may provide a browser-based or graphical configuration interface, and in some embodiments may be integrated with SDN orchestration functions.

Note that NFV orchestrator 1001 itself may be virtualized (rather than a special purpose hardware appliance). NFV orchestrator 1001 may be integrated within an existing SDN system, wherein an operations support system (OSS) manages the SDN. This may interact with cloud resource management systems (e.g., OpenStack) to provide NFV orchestration. An NFVI 1000 may include the hardware, software, and other infrastructure to enable VNFs to run. This may include a hardware platform 1002 on which one or more VMs 1004 may run. For example, hardware platform 1002-1 in this example runs VMs 1004-1 and 1004-2. Hardware platform 1002-2 runs VMs 1004-3 and 1004-4. Each hardware platform may include a hypervisor 1020, virtual machine manager (VMM), or similar function, which may include and run on a native (bare metal) operating system, which may be minimal so as to consume very few resources.

Hardware platforms 1002 may be or comprise a rack or several racks of blade or slot servers (including, e.g., processors, memory, and storage), one or more data centers, other hardware resources distributed across one or more geographic locations, hardware switches, or network interfaces. An NFVI 1000 may also include the software architecture that enables hypervisors to run and be managed by NFV orchestrator 1001.

Running on NFVI 1000 are a number of VMs 1004, each of which in this example is a VNF providing a virtual service appliance. Each VM 1004 in this example includes an instance of the Data Plane Development Kit (DPDK), a virtual operating system 1008, and an application providing the VNF 1012.

Virtualized network functions could include, as nonlimiting and illustrative examples, firewalls, intrusion detection systems, load balancers, routers, session border controllers, DPI services, network address translation (NAT) modules, or call security association.

The illustration of FIG. 10 shows that a number of VNFs 1004 have been provisioned and exist within NFVI 1000. This FIGURE does not necessarily illustrate any relationship between the VNFs and the larger network, or the packet flows that NFVI 1000 may employ.

The illustrated DPDK instances 1016 provide a set of highly-optimized libraries for communicating across a virtual switch (vSwitch) 1022. Like VMs 1004, vSwitch 1022 is provisioned and allocated by a hypervisor 1020. The hypervisor uses a network interface to connect the hardware platform to the data center fabric (e.g., a host fabric interface (HFI)). This HFI may be shared by all VMs 1004 running on a hardware platform 1002. Thus, a vSwitch may be allocated to switch traffic between VMs 1004. The vSwitch may be a pure software vSwitch (e.g., a shared memory vSwitch), which may be optimized so that data are not moved between memory locations, but rather, the data may stay in one place, and pointers may be passed between VMs 1004 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1022 is illustrated, wherein vSwitch 1022 is shared between two or more physical hardware platforms 1002.

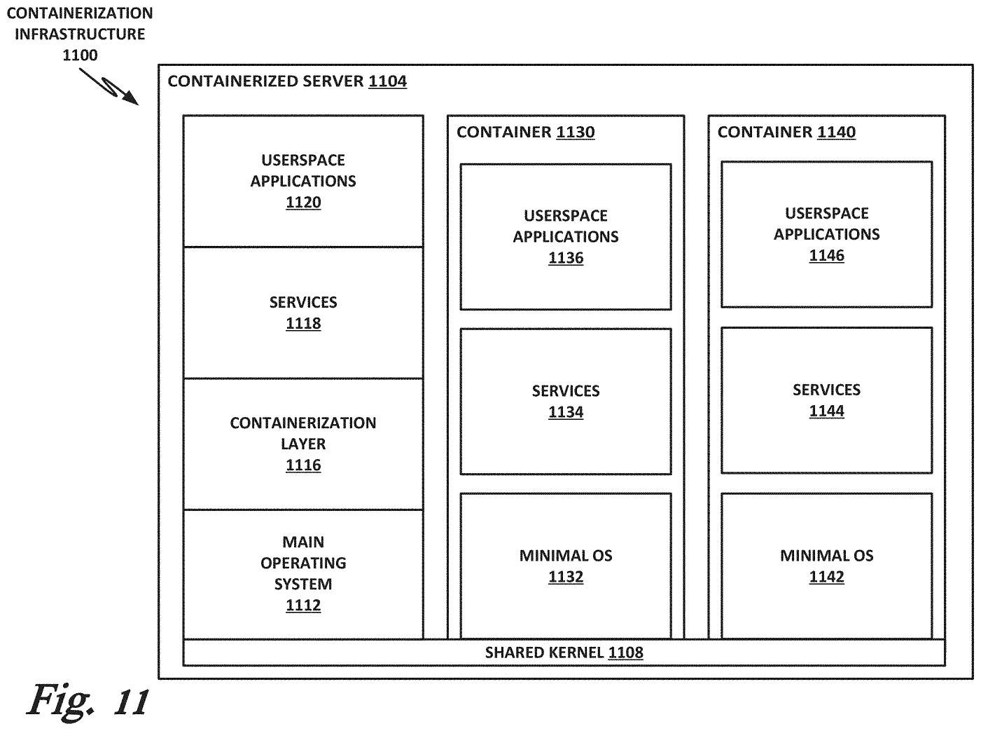

FIG. 11 is a block diagram of selected elements of a containerization infrastructure 1100. Like virtualization, containerization is a popular form of providing a guest infrastructure, and may be used instead of or in addition to virtualization (as in FIG. 10).

Containerization infrastructure 1100 runs on a hardware platform such as containerized server 1104. Containerized server 1104 may provide a number of processors, memory, one or more network interfaces, accelerators, and/or other hardware resources.

Running on containerized server 1104 is a shared kernel 1108. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1108 is main operating system 1112. Commonly, main operating system 1112 is a Unix or Linux-based operating system, although containerization infrastructure is also available for other types of systems, including Microsoft Windows systems and Macintosh systems. Running on top of main operating system 1112 is a containerization layer 1116. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer versus one without a daemon, like Podman. Such debates are outside the scope of the present specification, and when the present specification speaks of containerization, it is intended to include containerization layers, whether or not they require the use of a daemon.

Main operating system 1112 may also include a number of services 1118, which provide services and interprocess communication to userspace applications 1120.

Services 1118 and userspace applications 1120 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1112, they inherit the same file and resource access permissions as those provided by shared kernel 1108. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1104, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1104).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1104 hosts two containers, namely container 1130 and container 1140.

Container 1130 may include a minimal operating system 1132 that runs on top of shared kernel 1108. Note that a minimal operating system is provided as an illustrative example, and is not mandatory. In fact, container 1130 may perform as full an operating system as is necessary or desirable. Minimal operating system 1132 is used here as an example simply to illustrate that in common practice, the minimal operating system necessary to support the function of the container (which in common practice, is a single or monolithic function) is provided.

On top of minimal operating system 1132, container 1130 may provide one or more services 1134. Finally, on top of services 1134, container 1130 may also provide a number of userspace applications 1136, as necessary.

Container 1140 may include a minimal operating system 1142 that runs on top of shared kernel 1108. Note that a minimal operating system is provided as an illustrative example, and is not mandatory. In fact, container 1140 may perform as full an operating system as is necessary or desirable. Minimal operating system 1142 is used here as an example simply to illustrate that in common practice, the minimal operating system necessary to support the function of the container (which in common practice, is a single or monolithic function) is provided.

On top of minimal operating system 1142, container 1140 may provide one or more services 1144. Finally, on top of services 1144, container 1140 may also provide a number of userspace applications 1146, as necessary.

Using containerization layer 1116, containerized server 1104 may run a number of discrete containers, each one providing the minimal operating system and/or services necessary to provide a particular function. For example, containerized server 1104 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, non-transitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, non-transitory computer-readable storage media having stored thereon executable instructions that, when executed, cause a hardware platform or other computing system, to carry out a method or procedure. For example, the instructions could be executable object code, including software instructions executable by a processor. The one or more tangible, non-transitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other non-transitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

In-order to aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1. An end-user computing apparatus, comprising:
a hardware platform, comprising a processor and a memory; and
instructions encoded within the memory to:
provide two or more network activity scanners for a user's network activity;
operate the two or more network activity scanners to locally analyze the user's network activity, identify a plurality of online accounts associated with the user, and compute respective account identities and usage contexts for the accounts; and
send the account identities and usage contexts to an analysis service for identification of accounts to modify.

2. The end-user computing apparatus of claim 1, wherein the user contexts includes message header and/or metadata for messages, and omits message content.

3. The end-user computing apparatus of claim 1, wherein the analysis service is a cloud-based analysis service.

4. The end-user computing apparatus of claim 3, wherein the instructions are further to receive from the cloud-based analysis service a remedial action for an account, and implement the remedial action.

5. The end-user computing apparatus of claim 4, wherein implementing the remedial action comprises sending a message from the end-user computing apparatus to delete the account.

6. The end-user computing apparatus of claim 4, wherein implementing the remedial action comprises providing to the user instructions to delete the account.

7. The end-user computing apparatus of claim 4, wherein implementing the remedial action comprises providing a user interface for a one-click account reclamation.

8. The end-user computing apparatus of claim 4, wherein implementing the remedial action comprises querying the user for confirmation to delete the account.

9. The end-user computing apparatus of claim 1, wherein at least one of the network activity scanners is a scanner for a network activity other than email.

10. The end-user computing apparatus of claim 1, wherein at least one of the scanners is selected from the group consisting of email headers, short messaging service, chat service, stored passwords, autofill data, internet history, installed applications and phone logs.

11. The end-user computing apparatus of claim 1, wherein at least one of the network activity scanners is an email scanner that scans email headers and not email bodies.

12. The end-user computing apparatus of claim 11, wherein the instructions are further to access a cloud-based uniform resource locator (URL) reputation service to identify potential account activity from email headers.

13. The end-user computing apparatus of claim 1, wherein the end-user computing apparatus is selected from a mobile phone, a table, a laptop computer, a desktop computer, a workstation, a netbook, and a convertible tablet.

14-19. (canceled)

20. One or more tangible, non-transitory computer-readable storage media having stored thereon executable instructions to:
use at least two device-local network activity scanners to analyze a user's online account activity;
identify a plurality of online accounts associated with the user;
compute respective account identities and usage contexts for the online accounts; and
send the account identities and usage contexts to a cloud-based analysis service for identification of accounts to modify.

21. (canceled)

22. The one or more tangible, non-transitory computer-readable media of claim 20, wherein the analysis service is a cloud-based analysis service.

23. The one or more tangible, non-transitory computer-readable media of claim 22, wherein the instructions are further to receive from the cloud-based analysis service a remedial action for an account, and implement the remedial action.

24. (canceled)

25. The one or more tangible, non-transitory computer-readable media of claim 23, wherein implementing the remedial action comprises providing to the user instructions to delete the account.

26. The one or more tangible, non-transitory computer-readable media of claim 23, wherein implementing the remedial action comprises providing a user interface for a one-click account reclamation.

27.-31. (canceled)

32. A computer-implemented method, comprising:
using at least two device-local network activity scanners, analyzing a user's online account activity;
identifying a plurality of online accounts associated with the user;
computing respective account identities and usage contexts for the accounts; and
sending the account identities and usage contexts to a cloud-based analysis service for identification of accounts to modify.

33.-34. (canceled)

35. The method of claim 34, further comprising receiving from the cloud-based analysis service a remedial action for an account, and implement the remedial action.

36.-62. (canceled)
